(19) United States
(12) Patent Application Publication
(10) Pub. No.: US 2026/0191389 A1
(43) Pub. Date: Jul. 9, 2026

(54) OBJECT AVOIDANCE ON A MOBILE AUTONOMOUS ELECTRONIC SYSTEM

(71) Applicant: STMicroelectronics International N.V., Geneva (CH)

(72) Inventors: Giuseppe SPAMPINATO, Catania (IT); Arcangelo Ranieri BRUNA, Catania (IT)

(21) Appl. No.: 19/012,026

(22) Filed: Jan. 7, 2025

(51) Int. Cl. A47L 11/40; G05D 1/246; G05D 1/622; G05D 105/10; G05D 111/10

(52) U.S. Cl. CPC A47L 11/4061; A47L 11/4011; G05D 1/246; G05D 1/622; A47L 2201/04; G05D 2105/10; G05D 2111/10

(57) ABSTRACT

An example mobile autonomous electronic system for avoiding detected objects at a mobile autonomous electronic system is provided. The example mobile autonomous electronic system includes an optical ranging sensor, a rotation mechanism, a drive mechanism, and a controller. The optical ranging sensor generates a ranging metric for each pixel location in a detection field-of-view. The rotation mechanism rotates the system in a rotation direction. The drive mechanism drives the system relative to the rotation direction. The controller is configured to segment the field-of-view into vertical portions, generate a binary object detection map including a binary object detection value associated with each vertical portion based on ranging metrics, wherein the binary object detection value indicates a detected object in the associated vertical portion, and determine the rotation direction of the mobile autonomous electronic system to avoid the detected object based on the binary object detection map.

### TECHNOLOGICAL FIELD

Embodiments of the present disclosure relate generally to object avoidance on a mobile autonomous electronic system, and more particularly, to low-cost object avoidance utilizing a depth map.

### BACKGROUND

The convenience offered by smart technology has led to an ever increasing use of robotic devices, particularly smart home technology aimed at improving convenience and efficiency in daily tasks. These robotic devices may utilize advanced sensors, artificial intelligence, machine learning, and other technology to navigate spaces and perform tasks with minimal human intervention. Robotic vacuums, for example, can autonomously clean floors, map out rooms, and avoid obstacles, reducing the time and effort required for routine tasks. As technology continues to evolve, manufacturers seek to reduce cost and improve the functionality of these robotic devices.

Applicant has identified many technical challenges and difficulties associated with object avoidance on a robotic device. Through applied effort, ingenuity, and innovation, Applicant has solved problems related to the object detection on a robotic device by developing solutions embodied in the present disclosure, which are described in detail below.

### BRIEF SUMMARY

Various embodiments are directed to an example mobile autonomous electronic system, a computer-implemented method, and a computer program product for avoiding detected objects at a mobile autonomous electronic system.

An example mobile autonomous electronic system comprises an optical ranging sensor, a rotation mechanism, a drive mechanism, and a controller. The optical ranging sensor configured to generate a ranging metric for each pixel location in a detection field-of-view. The rotation mechanism configured to rotate the mobile autonomous electronic system in a rotation direction. The drive mechanism configured to drive the mobile autonomous electronic system relative to the rotation direction. The controller configured to segment the detection field-of-view into a plurality of vertical portions; generate a binary object detection map comprising a binary object detection value associated with each vertical portion based on a plurality of ranging metrics comprising the vertical portion, wherein the binary object detection value indicates a detected object in the associated vertical portion; and determine the rotation direction of the mobile autonomous electronic system to avoid the detected object based on the binary object detection map.

In some embodiments, the mobile autonomous electronic system further comprises a drive state, wherein the drive mechanism is enabled; and a rotate state, wherein the rotation mechanism rotates the mobile autonomous electronic system in the rotation direction.

In some embodiments, the controller is further configured to: store the rotation direction as a previous rotation direction.

In some embodiments, in an instance in which the rotation direction is uncertain, the controller is further configured to determine the rotation direction based on the previous rotation direction.

In some embodiments, in an instance in which the mobile autonomous electronic system enters the drive state, the controller is further configured to reset the previous rotation direction.

In some embodiments, the controller is further configured to determine a vertical portion ranging metric for each vertical portion based on the plurality of ranging metrics comprising the vertical portion.

In some embodiments, the plurality of vertical portions comprises a set of left vertical portions associated with a left side of the detection field-of-view; a set of right vertical portions associated with a right side of the detection field-of-view; and a set of center vertical portions associated with a center portion of the detection field-of-view.

In some embodiments, in an instance in which the binary object detection value associated with each vertical portion comprising the set of center vertical portions indicates no detected object, the controller enters the drive state of the mobile autonomous electronic system and activates the drive mechanism.

In some embodiments, in an instance in which at least one of the binary object detection values of the set of center vertical portions indicates the detected object, the rotation direction is selected based on the binary object detection map and the vertical portion ranging metric associated with the set of left vertical portions and right vertical portions.

In some embodiments, in an instance in which the rotation direction is uncertain, the rotation direction is determined based on the vertical portion ranging metrics associated with each vertical portion.

In some embodiments, the binary object detection value is determined by comparing the vertical portion ranging metric of a vertical portion with a detected object threshold.

In some embodiments, the plurality of vertical portions includes four vertical portions.

An example computer-implemented method for avoiding detected objects on a mobile autonomous electronic system is further provided. In some embodiments, the example computer-implemented method comprises: determining a ranging metric for each pixel location in a detection field-of-view of an optical ranging sensor; segmenting the detection field-of-view into a plurality of vertical portions; generating a binary object detection map comprising a binary object detection value associated with each vertical portion based on a plurality of ranging metrics comprising the vertical portion, wherein the binary object detection value indicates a detected object in the associated vertical portion; and determining a rotation direction of the mobile autonomous electronic system to avoid the detected object based on the binary object detection map.

In some embodiments, the method further comprises storing the rotation direction as a previous rotation direction.

In some embodiments, in an instance in which the rotation direction is uncertain, the computer-implemented method further comprises determine the rotation direction based on the previous rotation direction.

In some embodiments, the method further comprises determining a vertical portion ranging metric for each vertical portion based on the plurality of ranging metrics comprising the vertical portion.

In some embodiments, in an instance in which the binary object detection value associated with each vertical portion comprising a set of center vertical portions associated with a center portion of the detection field-of-view indicates no detected object, the computer-implemented method further comprises: entering a drive state of the mobile autonomous electronic system; and activating a drive mechanism on the mobile autonomous electronic system.

In some embodiments, in an instance in which the mobile autonomous electronic system enters the drive state, the computer-implemented method further comprises: resetting the previous rotation direction.

In some embodiments, the binary object detection value is determined by comparing the vertical portion ranging metric of a vertical portion with a detected object threshold.

An example computer program product for avoiding detected objects on a mobile autonomous electronic system is further provided. In some embodiments, the example computer program product comprises at least one non-transitory computer-readable storage medium having computer-readable program code portions stored therein, the computer-readable program code portions comprising an executable portion configured to: determine a ranging metric for each pixel location in a detection field-of-view of an optical ranging sensor; segment the detection field-of-view into a plurality of vertical portions; generate a binary object detection map comprising a binary object detection value associated with each vertical portion based on a plurality of ranging metrics comprising the vertical portion, wherein the binary object detection value indicates a detected object in the associated vertical portion; and determine a rotation direction of the mobile autonomous electronic system to avoid the detected object based on the binary object detection map.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of a mobile autonomous electronic system in accordance with an example embodiment of the present disclosure.

FIG. 2 illustrates a flowchart depicting an example process for avoiding detected objects on a mobile autonomous electronic system in accordance with an example embodiment of the present disclosure.

FIG. 3 illustrates a flowchart depicting an example process for determining a rotation direction on a mobile autonomous electronic system in accordance with an example embodiment of the present disclosure.

FIG. 4 illustrates an example state diagram for a mobile autonomous electronic system operating in accordance with an example embodiment of the present disclosure.

FIG. 5 illustrates an example detection field-of-view in accordance with an example embodiment of the present disclosure.

FIG. 6 depicts a plurality of example binary object detection maps in accordance with an example embodiment of the present disclosure.

FIG. 7 depicts an example mobile autonomous electronic system in accordance with an example embodiment of the present disclosure.

FIG. 8 depicts example components of a controller in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with avoiding detected objects on a mobile autonomous electronic system. As understood by those of skill in the field to which the present disclosure pertains, there are numerous example scenarios in which a mobile autonomous electronic system may benefit from improved, low-cost detected object avoidance techniques.

For example, the convenience offered by smart technology has led to an ever increasing use of mobile autonomous electronic systems (e.g., robotic devices), particularly smart home technology systems aimed at improving convenience and efficiency in daily tasks. These mobile autonomous electronic systems may utilize advanced sensors, artificial intelligence, machine learning, and other technology to navigate spaces and perform tasks with minimal human intervention. Robotic vacuums, for example, can autonomously clean floors, map out rooms, and avoid obstacles, reducing the time and effort required for routine cleaning tasks. As technology continues to evolve, manufacturers seek to reduce cost and improve the functionality of these mobile autonomous electronic systems.

Typically, mobile autonomous electronic systems implement some form of detected object avoidance. Detected object avoidance is a critical aspect of navigation and control systems on a mobile autonomous electronic system. Detected object avoidance is the capability of a mobile autonomous electronic system to detect and circumvent obstacles in its path.

Many detected object avoidance algorithms are dependent upon high resolution depth maps and/or large field of views. In addition, detected object avoidance algorithms are prone to errors, for example, undesirable rotations or loops, especially in the presence of small obstacles. Further, many detected object avoidance algorithms are extremely complex to implement, operate, and execute. As such, there is a need for detected object avoidance algorithms configured to operate on a low cost system and with low power consumption. In addition, there is a need for detected object avoidance algorithms that may readily exploit data and execution parallelism to speed up execution time.

The various example embodiments described herein utilize various techniques to perform accurate detected object avoidance at a low cost. For example, in some embodiments, the detected object avoidance process described herein may utilize a depth map based on a detection field-of-view of an optical ranging sensor. The detected object avoidance process may segment the depth map into a plurality of vertical portions, for example, four vertical portions. Each vertical portion may comprise a plurality of pixels containing depth information in the detection field-of-view based on reflected light received at the optical ranging sensor.

In some embodiments, the detected object avoidance process may determine a vertical portion ranging metric for each vertical portion of the detection field-of-view. A vertical portion ranging metric comprises data or values representing a distance to one or more objects observed in the vertical portion of the detection field-of-view. For example, the vertical portion ranging metric may comprise an average depth value for each of the depth values of the plurality of pixels comprising the detection field-of-view. In some embodiments, the vertical portion ranging metric may comprise a minimum depth value associated with one or more pixel locations in the vertical portion.

Based on the vertical portion ranging metric of each vertical portion, a binary object detection value may be determined. A binary object detection value indicates whether an objected was detected in the vertical portion. For example, a one may indicate an object is detected in the associated vertical portion, while a zero indicates no object is detected in the vertical portion. In some embodiments, the vertical portion ranging metric for a particular vertical portion may be compared to a detected object threshold to determine the binary object detection value for the particular vertical portion. A binary object detection map indicating the binary object detection value for each vertical portion of the detection field-of-view may be generated.

The binary object detection map may be used to determine a rotation direction of the mobile autonomous electronic system. For example, a set of one or more left vertical portions associated with the left side of the detection field-of-view, a set of right vertical portions associated with the right side of the detection field-of-view, and a set of center vertical portions associated with a center portion of the detection field-of-view may be defined. The rotation direction may be determined based on each of these sets of vertical portions.

In some embodiments, the rotation direction may be stored such that future rotation direction determinations may be made based on the past selected rotation directions. For example, while in a rotate state of the detected object avoidance process, the previous rotation direction may be stored to prevent the mobile autonomous electronic system from oscillating between two different rotation directions when determining a traversal path. Further, once a clear traversal path is found, and the mobile autonomous electronic system enters into a drive state, the stored rotation direction may be cleared. In this way, either rotation direction may once again be selected once another detected object is encountered.

Segmenting the detection field-of-view of a depth into vertical portions and determining a single binary object detection value for the vertical portion may enable the disclosed detected object avoidance process to operate with low-resolution optical ranging sensors. Utilizing low-resolution optical ranging sensors may reduce the overall cost of the mobile autonomous electronic system. In addition, segmenting the detection field-of-view into vertical portions may enable parallel operations to be performed on each of the vertical portions simultaneously. Parallel operations may increase the performance of the detected object avoidance process on a mobile autonomous electronic system. As a result of the herein described example embodiments, the mobile autonomous electronic system may experience increased speeds and reduced power consumption. In addition, the utilization of vertical portions of the detection field-of-view to down sample the depth map portions may enable the detected object avoidance process of the present disclosure to operate in conjunction with low-cost imaging devices.

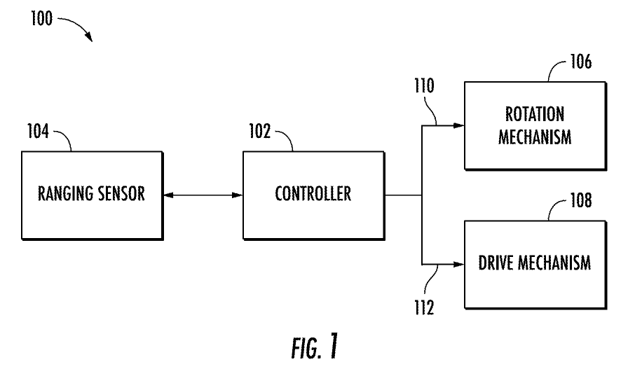

Referring now to FIG. 1, an example mobile autonomous electronic system 100 is provided. As depicted in FIG. 1, the example mobile autonomous electronic system 100 includes a controller 102 electrically connected to an optical ranging sensor 104. In addition, the controller 102 is electrically connected to a drive mechanism 108 and a rotation mechanism 106.

As depicted in FIG. 1, the example mobile autonomous electronic system 100 includes an optical ranging sensor 104. An optical ranging sensor 104 comprises any sensing device configured to determine a distance to any in-range target object or plurality of target objects within a detection field-of-view of the optical ranging sensor 104 based on a transmitted electromagnetic wave. In general, an optical ranging sensor 104 operates by measuring the time it takes for an optical signal, usually emitted as a laser or infrared pulse, to travel to a target object and reflect back to the sensor. The optical ranging sensor calculates the distance to the target object based on the speed of light and the time delay between the emission and detection of the optical signal. The optical ranging sensor 104 and the reflected optical signal may be used to measure a distance to the target object, track the motion of the target object, determine a speed of the target object, detect presence of a target object, determine material properties of a target object, and/or map target objects in an environment with high precision.

The optical ranging sensor 104 may be configured to detect target objects within a detection field-of-view. A detection field-of-view view is an angular range for which the optical ranging sensor 104 may detect target objects. The detection field-of-view for an optical ranging sensor 104 may be defined based on the field-of-view angle of an optical transmitter and/or optical receiver included on the optical ranging sensor 104.

The optical ranging sensor 104 and/or controller 102 may be configured to generate a depth map associated with the detection field-of-view. For example, the optical ranging sensor 104 may include an optical receiver having an array of light-sensitive elements (e.g., pixels). Each pixel may correspond with a real-world location in the detection field-of-view. The electrical output from each pixel may correspond to the amount of light received from the corresponding real-world location. In an instance in which the electrical output is accumulated for a specific time period relative to the generation of the transmitted optical signal, the optical ranging sensor 104 may generate a depth histogram for each pixel location. The depth histogram may be utilized to determine a depth value to the nearest target object at each pixel location. In an instance in which the electrical output is accumulated for a specific time period relative to the generation of the transmitted optical signal, the optical ranging sensor 104 and/or controller 102 may generate an intensity value for each pixel location based on the intensity of light received at the pixel location during the integration time period.

The techniques of the detected object avoidance process described herein may enable operation of an optical ranging sensor and associated depth map with a low resolution. For example, in some embodiments, the depth map may comprise an 8x8 two-dimensional array of pixel locations.

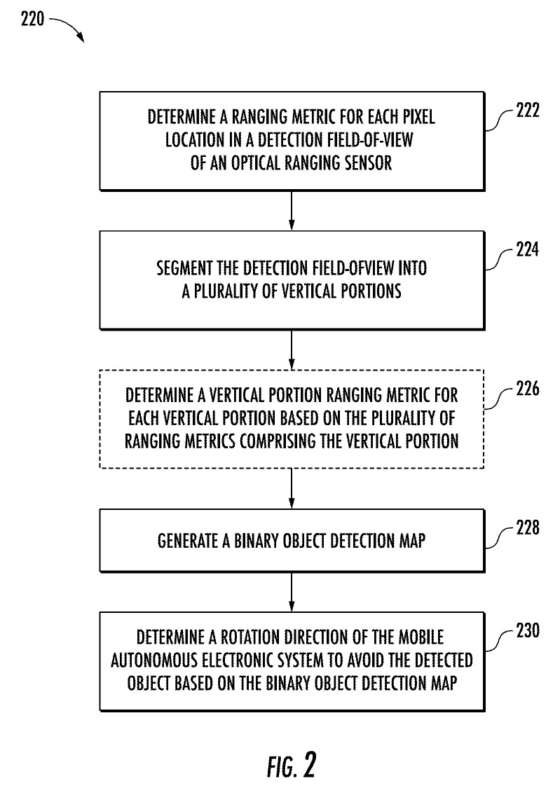

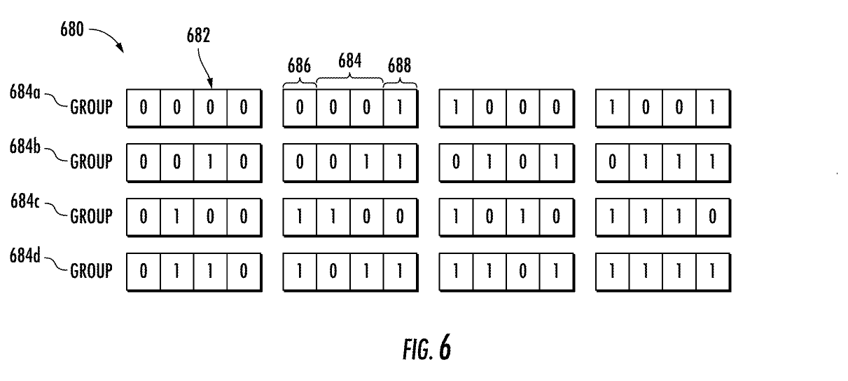

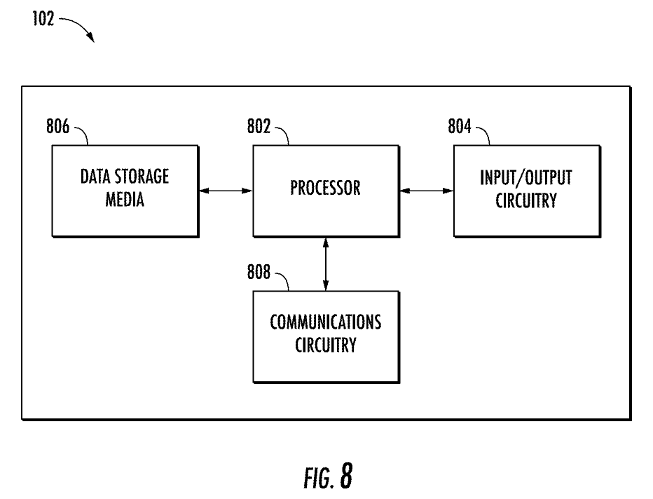

As further depicted in FIG. 1, the mobile autonomous electronic system 100 includes a controller 102. A controller 102 comprises any circuitry including hardware and/or software configured to receive an electrical output from the optical ranging sensor 104 and generate control signals (e.g., rotation commands 110, drive commands 112) based on the execution of a detected object avoidance process. For example, rotation commands 110 may be transmitted to the rotation mechanism 106 and drive commands 112 transmitted to the drive mechanism 108 based on the detected object avoidance process. The detected object avoidance process is further described in relation to FIG. 2 – FIG. 6. A block diagram of an example architecture of a controller 102 is further described in relation to FIG. 8.

As further depicted in FIG. 1, the mobile autonomous electronic system 100 includes a rotation mechanism 106. A rotation mechanism 106 is any electrical and/or mechanical structures configured to rotate the mobile autonomous electronic system 100 about a center axis based on a received rotation command 110. In some embodiments, the mobile autonomous electronic system 100 may include two or more wheels connected to a motor. The rotation mechanism 106 may perform a rotation by causing the rotation of one or more wheels connected to the motor. For example, operating two separate wheels at different rotational speeds may cause the mobile autonomous electronic system 100 to rotate.

The rotation mechanism 106 may rotate according to a direction and an amount. The direction may be expressed as a body relative direction, for example, left and right, where the direction of transmission of the optical transmitter is forward. The rotation direction may also be expressed as a rotational direction, for example, clockwise and counter-clockwise. As described herein, left corresponds to counter-clockwise and right corresponds to clockwise. The rotation amount may be expressed in units of angle, such as degrees or radians. In some embodiments, the amount of rotation is fixed, for example, fixed at 15 degrees. In such an embodiment, any command to rotate left, rotates the mobile autonomous electronic system 100 left for 15 degrees. Any command to rotate right, rotates the mobile autonomous electronic system 100 right for 15 degrees. Thus, as described herein, rotation commands 110 specifying only a direction rotate in the direction for the fixed rotation amount.

As further depicted in FIG. 1, the mobile autonomous electronic system 100 includes a drive mechanism 108. The drive mechanism 108 is any electrical and/or mechanical structures configured to move the mobile autonomous electronic system 100 in a forward or backward direction. In some embodiments, the mobile autonomous electronic system 100 may include two or more wheels connected to a motor. The drive mechanism 108 may drive the mobile autonomous electronic system 100 by causing the rotation of one or more wheels connected to the motor in sequence.

The drive mechanism 108 may drive the mobile autonomous electronic system 100 according to a direction and a speed based on one or more drive commands 112. The direction may be expressed as a body relative direction, for example, forward, backward, left, or right, where the direction of transmission of the optical transmitter is forward. As described herein, unless otherwise specified, any drive command is in the forward direction, for example, in the direction to optical ranging sensor 104 is configured to transmit.

Referring now to FIG. 2, an example detected object avoidance process 220 is provided. At block 222, the controller (e.g., controller 102) determines a ranging metric for each pixel location in a detection field-of-view of an optical ranging sensor. As described herein, a mobile autonomous electronic system (e.g., mobile autonomous electronic system 100) includes an optical ranging sensor (e.g., optical ranging sensor 104) configured to transmit optical signals by an optical transmitter, receive signals by an optical receiver, and generate an electrical output based on the amount of light received at each pixel location. Based on the electrical output from the optical ranging sensor, the controller may determine a ranging metric for each pixel location.

A ranging metric comprises any data or value representing a distance to a nearest target object corresponding to a real-world location associated with the pixel location. In some embodiments, the ranging metric of a pixel location may correspond to depth value or intensity value. For example, a depth value may be determined based on the elapsed time between the transmission of an optical signal of the optical ranging sensor and the reception of the reflected optical signal at the pixel location on the optical receiver or the optical ranging sensor. An intensity value may be associated with the amount of light received at a pixel location during an integration time period. The intensity value may correspond to a distance to a target object in an external environment.

In some embodiments, the controller may generate a two-dimensional depth map (or image). A depth map or image may comprise a set or array of ranging metrics, each ranging metric corresponding to a pixel location. For example, a ranging metric map may comprise a two-dimensional array, wherein each value in the two-dimensional array corresponds to a ranging metric of a pixel location. In such an embodiment, the ranging metrics of each pixel may be accessed based on pixel location.

The pixel locations comprising the depth map (or image) correspond to the detection field-of-view of the optical ranging sensor. For example, each pixel location in the depth map may correspond to a portion of the detection field-of-view of the optical ranging sensor. The entirety of the depth map corresponding to the entirety of the detection field-of-view.

At block 224, the controller segments the detection field-of-view into a plurality of vertical portions. A controller may utilize any mechanism to segment the detection field-of-view into vertical portions. For example, in an embodiment in which a depth map is generated, each pixel location of the depth map may be associated with an x and y location, wherein the x location represents the horizontal location of the pixel location in the detection field-of-view and the y location represents the vertical location of the pixel location in the detection field-of-view. Thus, the vertical portions may be defined by x location.

For example, in an instance in which the controller segments the detection field-of-view into four vertical portions, a first portion may correspond to pixel locations having an x location between 0 and 25% of the depth map width. A second portion may correspond to pixel locations having an x location between 25% of the depth map width and 50% of the depth map width. A third portion may correspond to pixel locations having an x location between 50% of the depth map width and 75% of the depth map width. A fourth portion may correspond to pixel locations having an x location between 75% of the depth map width and the end of the depth map.

At block 226, the controller determines a vertical portion ranging metric for each vertical portion based on the plurality of ranging metrics comprising the vertical portion. The controller may utilize any mechanism to access the pixel locations comprising a vertical portion. In some embodiments, each of the vertical portions may be accessed in parallel and determination of the vertical portion ranging metric for each vertical portion may be determined in parallel.

The vertical portion ranging metric comprises any data or value representing the depth of the vertical portion of the detection field-of-view based on the ranging metrics of the pixel locations included in the vertical portion. In some embodiments, the vertical portion ranging metric may be a statistical representation of the ranging metrics within the vertical portion of the detection field-of-view. For example, an average, mean, median, mode, or other statistical value may be determined based on the ranging metrics of the pixel locations within the vertical portion. In some embodiments, the vertical portion ranging metric may be based on the minimum ranging metric of the pixel location ranging metrics within the vertical portion, for example, representing the closest detected object detected within the vertical portion. In some embodiments, outlier data may be ignored in the determination of the vertical portion ranging metric.

At block 228, the controller generates a binary object detection map comprising a binary object detection value associated with each vertical portion based on a plurality of ranging metrics comprising the vertical portion, wherein the binary object detection value indicates a detected object in the associated vertical portion. A binary object detection value comprises any value indicating the presence of a detected object within the associated vertical portion. For clarity, as described herein, a logic one may indicate the presence of a detected object within the vertical portion, conversely, a logic zero may indicate no detected object was detected in the vertical portion of the detection field-of-view. In some embodiments, the binary object detection value for an associated vertical portion may be based on the plurality of ranging metrics for each of the pixel locations within the vertical portion.

A controller may utilize any mechanism to determine the binary object detection value for each vertical portion of the detection field-of-view. In one example, a controller may determine a detected object based on the proximity of a detected object indicated by on one or more ranging metrics of the plurality of pixel locations comprising the vertical portion. In such an example, one or more ranging metrics indicating a detected object within a threshold distance of the mobile autonomous electronic system may result in a binary object detection value for the vertical portion indicating a detected object. In another example, a controller may determine a detected object and assert (e.g., set to one) a binary object detection value for the associated vertical portion based on a number of ranging metrics exceeding or below a threshold amount. In such an example, the controller may count the number of ranging metrics of the pixel locations indicating a detected object within a threshold distance, in an instance in which the counted number of ranging metrics exceeds a threshold amount, the binary object detection value may be asserted (e.g., set to one). In another example, a controller may determine a detected object and assert (e.g., set to one) a binary object detection value for the associated vertical portion based on a grouping of ranging metrics exceeding or below a threshold amount. In such an example, the controller may determine a size and/or shape of one or more groups of ranging metrics of the pixel locations indicating a detected object within a threshold distance, in an instance in which the size or shape of the group indicates a particular detected object or detected object size, the binary object detection value may be asserted (e.g., set to one).

In some embodiments, determination of the binary object detection value for each vertical portion may be determined in parallel. For example, the ranging metrics for each vertical portion may be read and analyzed in parallel process and the corresponding binary object detection value determined in parallel.

The binary object detection values for each vertical portion of the detection field-of-view are stored in a binary object detection map. A binary object detection map comprises a binary object detection value for each vertical portion in a list, set, map, or other similar data structure. For example, a binary object detection map may include a binary object detection value for each vertical portion and each binary object detection value may be accessible by vertical portion. In such an example, the first binary object detection value in a data set may correspond to the leftmost vertical portion of the detection field-of-view, the next binary object detection value corresponding to the next vertical portion to the right of the first vertical portion, and so on until the last binary object detection value in the data set corresponds to the rightmost vertical portion of the detection field-of-view. Example binary object detection maps are described further in relation to FIG. 6.

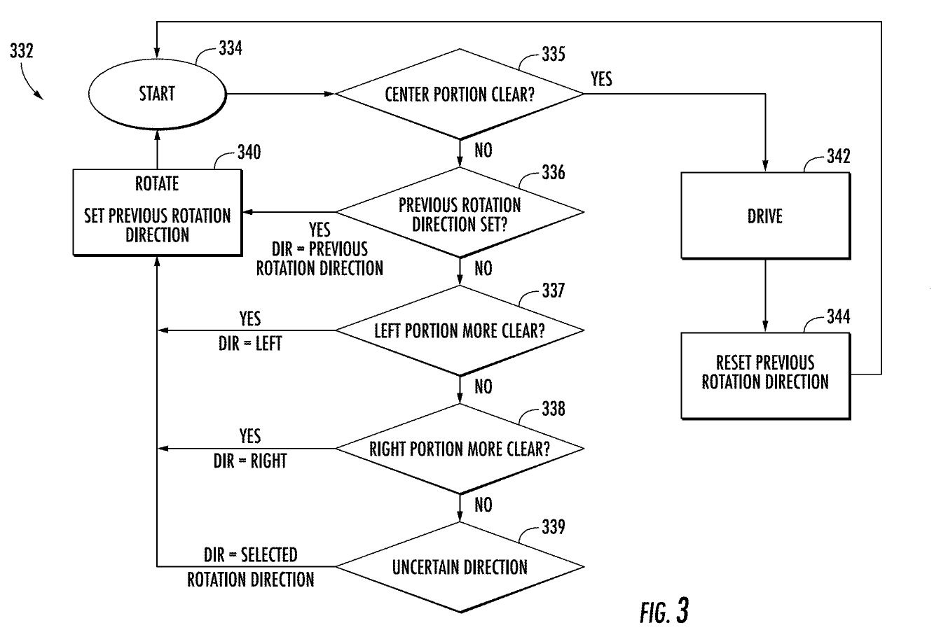

At block 230, the controller determines a rotation direction of the mobile autonomous electronic system to avoid the detected object based on the binary object detection map. In general, a rotation direction corresponds to a rotation direction (e.g., left/right, clockwise/counterclockwise) and a rotation amount (e.g., 10 degrees, 15 degrees, 20 degrees). The rotation direction is determined based on the binary object detection values within the binary object detection map and a stored previous rotation direction. An example process for determining a rotation direction on a mobile autonomous electronic system is described in relation to FIG. 3.

Referring now to FIG. 3, a flowchart depicting an example process 332 for determining a rotation direction in a detected object avoidance process (e.g., detected object avoidance process 220) on a mobile autonomous electronic system (e.g., mobile autonomous electronic system 100) is provided. In some embodiments, the process 332 may be executed on a controller (e.g., controller 102) of the mobile autonomous electronic system in conjunction with the detected object avoidance process.

The process 332 begins at block 334, where the controller directs execution to block 335.

At block 335, the controller determines if the center portion of the detection field-of-view is free of detected objects. The controller may utilize a set of center vertical portions associated with the center portion of the detection field-of-view to determine if there are any detected objects in the forward direction of the mobile autonomous electronic system. The plurality of vertical portions comprising the detection field-of-view includes a set of center vertical portions. The set of center vertical portions includes one or more vertical portions at or near the center of the detection field-of-view. The number of vertical portions comprising the set of center vertical portions may depend on the total number of vertical portions, the resolution of the optical ranging sensor, and/or the size of the mobile autonomous electronic system. In some embodiments, the number of vertical portions comprising the plurality of vertical portions may be reduced, or down-sampled until there are four vertical portions.

The controller may utilize the set of center vertical portions to determine if a detected object is directly in front of the mobile autonomous electronic system. For example, in an instance in which the binary object detection value associated with each vertical portion comprising the set of center vertical portions indicates no detected objects, the controller may determine that the center portion of the detection field-of-view is clear of detected objects.

In an instance in which the center portion of the detection field-of-view is clear of detected objects, execution continues at block 342.

In an instance in which one or more of the binary object detection values associated with the set of center vertical portions indicates a detected object, execution continues at block 336.

At block 336, the controller checks if the previous rotation direction is set. In an instance in which the previous rotation direction is set, the rotation direction is set to the pervious rotation direction and execution continues at block 340. In general, in an instance in which the process 332 determines a rotation direction initially after first stopping, the previous rotation direction is not set (see block 344). However, once a first rotation determination is made, the previous rotation direction is set and may be considered in determining a subsequent rotation direction. In an instance in which the previous rotation direction is not set, execution continues at block 337. Utilizing the previous rotation direction may prevent unwanted behavior of the mobile autonomous electronic system, for example, unwanted rotations.

At block 337, the controller determines if the left portion of the detection field-of-view is more clear with respect to detected objects relative to the right portion of the detection field-of-view. Since, the controller has determined the center portion of the detection field-of-view is not clear in block 335 and that the previous rotation direction is not set, the controller must select a new rotation direction.

The plurality of vertical portions may further include a set of left vertical portions comprising the vertical portions to the left of the set of center vertical portions, and a set of right vertical portions comprising the vertical portions to the right of the set of center vertical portions. The controller utilizes the set of left vertical portions and the set of right vertical portions to determine the selected rotation. For example, if the binary object detection values of the set of left vertical portions indicate a clear path is more likely to the left, the controller will choose a counter-clockwise (or left) rotation direction. In some embodiments, one or more of the set of center vertical portions may be considered in determining whether the left side of the detection field-of-view is relatively more open compared to the right side of the detection field-of-view. For example, if both the set of right vertical portions and the set of left vertical portions are clear, but the center vertical portion indicating a detected object is on the right side of the center portion, the controller may determine that the left portion of the detection field-of-view is more clear of detected objects compared to the right side. Example binary object detection maps for a detection field-of-view comprising four vertical portions and corresponding selected rotation directions are further described in relation to FIG. 6.

In an instance in which the controller determines the left of the detection field-of-view is more clear with respect to detected objects than the right side, the rotation direction is set to left (or counter-clockwise) and execution continues at block 340.

In an instance in which the controller fails to determine the left of the detection field-of-view is not more clear with respect to detected objects compared to the right of the detection field-of-view, execution continues at block 338.

At block 338, the controller determines if the right portion of the detection field-of-view is more clear with respect to detected objects relative to the left portion of the detection field-of-view.

The controller utilizes the set of right vertical portions and the set of left vertical portions to determine an instance in which the right of the detection field-of-view is comparatively more clear than the left side of the detection field-of-view. For example, if the binary object detection values of the set of right vertical portions indicate a clear path is more likely to the right, the controller will choose a clockwise (or right) rotation direction. In some embodiments, one or more of the set of center vertical portions may be considered in determining whether the right side of the detection field-of-view is relatively more clear compared to the left side of the detection field-of-view. For example, if both the set of right vertical portions and the set of left vertical portions are clear, but the center vertical portion indicating a detected object is on the left side of the center portion, the controller may determine that the right portion of the detection field-of-view is more clear of detected objects compared to the left side. Example binary object detection maps for a detection field-of-view comprising four vertical portions and corresponding selected rotation directions are further described in relation to FIG. 6.

In an instance in which the controller determines the right of the detection field-of-view is more clear of detected objects than the left side, the rotation direction is set to right (or clockwise) and execution continues at block 340.

In an instance in which the controller fails to determine the right of the detection field-of-view is not more clear of detected objects compared to the left of the detection field-of-view, execution continues at block 339.

At block 339, the selected rotation direction is uncertain based on the binary object detection values associated with each of the vertical portions of the detection field-of-view. For example, both the left portion of the detection field-of-view and the right portion of the detection field-of-view indicate a detected object. Or, neither the left portion of the detection field-of-view or the right portion of the detection field-of-view indicate a detected object. In such an instance in which the selected direction is uncertain based on the binary object detection values of the vertical portions of the detection field-of-view, the controller may utilize the vertical portion ranging metrics of each vertical portion to determine the selected rotation direction.

The controller may utilize any mechanism or algorithm to determine the rotation direction based on the vertical portion ranging metrics. For example, the controller may determine which vertical portion of the detection field-of-view indicates the closest detected object and turn away from the closest detected object. For example, if the vertical portion indicating the closest detected object is on the right side of the detected field-of-view, the controller may select the rotation direction to the left (e.g., counter-clockwise).

Once a selected rotation direction is determined, execution continues at block 340.

At block 340, the controller sets the previous rotation direction to the selected rotation direction. The controller further executes a rotation of the mobile autonomous electronic system for example, by issuing a rotation command (e.g., rotation command 110) to the rotation mechanism (e.g., rotation mechanism 106). Once the rotation command is transmitted, execution continues at the start block 334.

At block 342, the controller issues one or more drive commands (e.g., drive command 112) to activate the drive mechanism (e.g., drive mechanism 108) on the mobile autonomous electronic system and cause the mobile autonomous electronic system to move in a forward direction. Further, at block 344, the previous rotation direction is reset. In an instance in which the controller determines there are no detected objects in front of the mobile autonomous electronic system and begins to drive forward, the controller resets any previous rotation direction. Thus, the next time the mobile autonomous electronic system stops to determine a rotation direction, the previous rotation direction is not set. After the previous rotation direction is set at block 344, execution continues at the start block 334.

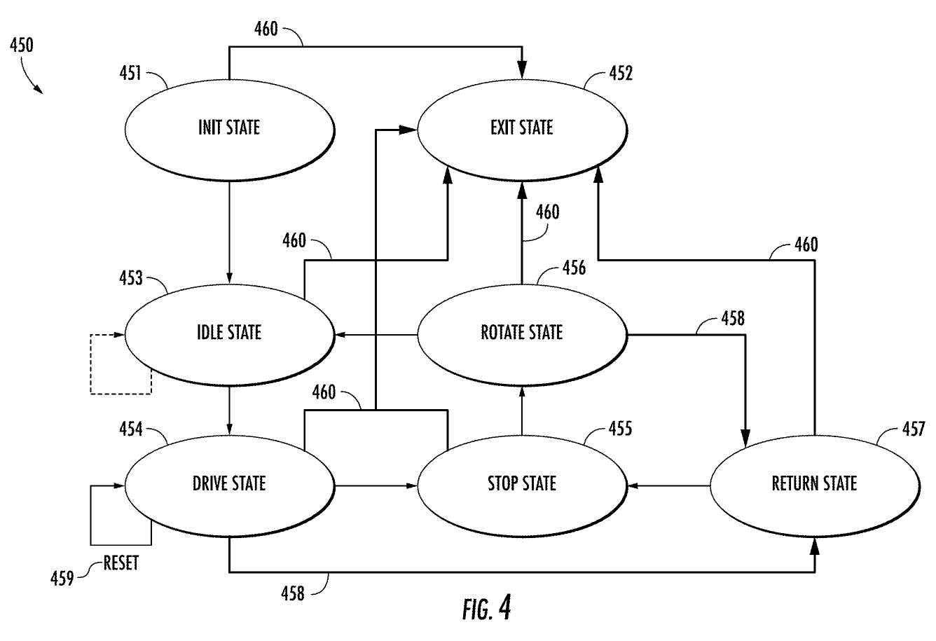

Referring now to FIG. 4, an example state diagram 450 of a controller (e.g., controller 102) operating a detected object avoidance process (e.g., object avoidance process 220) in accordance with the present disclosure on a mobile autonomous electronic system (e.g., mobile autonomous electronic system 100), is depicted.

The controller begins operation at the initialization state 451. At the initialization state 451 various initialization operations are performed. Including power startup operations, memory initialization operations, loading operations, and other operations necessary to begin operation of the mobile autonomous electronic system.

Operation continues at idle state 453. At the idle state 453 various checks on the mobile autonomous electronic system are performed. Checks may include motor checks, time-of-flight checks, camera checks, sensor checks, connection checks, and so on. In some embodiments, operation may remain in the idle state 453 until a command to begin driving is received. Upon completion of the checks and/or reception of a drive command, operation continues at drive state 454.

At drive state 454, the drive mechanism (e.g., drive mechanism 108) of the mobile autonomous electronic system is activated and the mobile autonomous electronic system begins to drive in a forward direction. In addition, a reset command 459 may be issued, resetting any previous rotation direction set in the rotate state 456. The mobile autonomous electronic system continues to move forward until an object is detected in the detection field-of-view of an optical ranging sensor. Once an object is detected, operation continues at stop state 455.

In addition, while in the drive state 454, a return command 458 may cause operation to continue at the return state 457. A return command 458 may be issued in an instance in which the mobile autonomous electronic system continues in the drive state 454 but cannot move. For example, in an instance in which an obstacle is blocking the path of the mobile autonomous electronic system but is not detected by the optical ranging sensor. Such a situation may occur in an instance in which the optical ranging sensor is higher than the obstacle, or the obstacle is particularly absorbent or reflective of the light transmitted by the optical ranging sensor.

At stop state 455, the drive mechanism of the mobile autonomous electronic system causes the mobile autonomous electronic system to stop. Operation continues at rotate state 456.

At rotate state 456, the detected object avoidance processes (e.g., detected object avoidance process 220, example process 332 for determining a rotation direction) are executed to determine a rotation direction. Further, the rotation of the mobile autonomous electronic system is executed until the forward direction of the mobile autonomous electronic system is clear of any detected objects. Once a rotation direction is determined, operation continues at the idle state 453. A return command 458 may cause operation to continue at the return state 457.

At return state 457, the drive mechanism of the mobile autonomous electronic system causes the mobile autonomous electronic system to drive backward for a fixed distance. In some embodiments, the rotation mechanism may also rotate the mobile autonomous electronic system for a fixed rotation distance.

In each state, an error command 460 may be issued. An error command 460 may be issued by any system of the mobile autonomous electronic system. When an error command is received, operation continues to the exit state 452 where the mobile autonomous electronic system is stopped definitively.

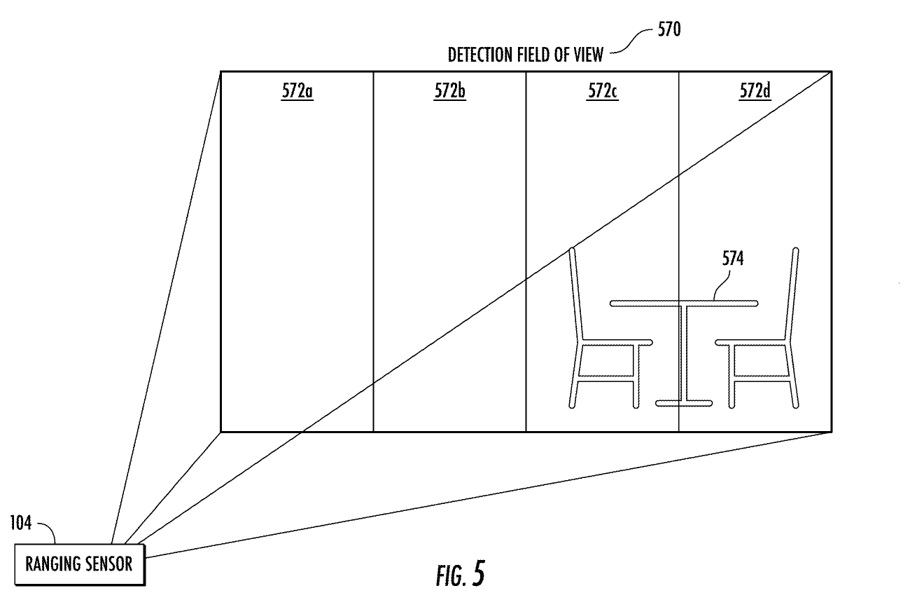

Referring now to FIG. 5, an example detection field-of-view 570 of an optical ranging sensor 104, segmented into four vertical portions 572a – 572d is depicted. In addition, a plurality of detected objects 574 are depicted in the third vertical portion 572c and the fourth vertical portion 572d of the detection field-of-view.

As depicted in FIG. 5, the optical ranging sensor 104 is configured to detect objects (e.g., detected objects 574) within a detection field-of-view 570. A detection field-of-view 570 is an angular range for which the optical ranging sensor 104 may detect target objects. The detection field-of-view for an optical ranging sensor 104 may be defined based on the field-of-view angle of an optical transmitter and/or optical receiver included on the optical ranging sensor 104. The optical ranging sensor 104 may generate a depth image (or intensity image) based on the detection field-of-view 570. For example, the optical ranging sensor 104 may comprise a plurality of pixels arranged in a two-dimensional array wherein each pixel corresponds with a real-world location in the detection field-of-view 570. The detected object avoidance processes described herein may enable a mobile autonomous electronic system to operate utilizing a low resolution optical ranging sensor. For example, an 8x8 pixel optical ranging sensor 104.

As further depicted in FIG. 5, the detection field-of-view 570 is divided into equally-sized vertical portions 572a – 572d. Each vertical portion is associated with a binary object detection value. The binary object detection value indicates whether an object has been detected in the associated vertical portion 572a – 572d. For example, in the detection field-of-view 570 depicted in FIG. 5, the detected object 574 may cause the binary object detection values to be asserted in the third vertical portion 572c and the fourth vertical portion 572d. Thus, a binary object detection map may comprise the values [0, 0, 1, 1].

The binary object detection value associated with each vertical portion 572a – 572d may be based on a vertical portion ranging metric. A vertical portion ranging metric is determined to represent a depth measurement of the vertical portion of the detection field-of-view based on the ranging metrics of the pixel locations included in the vertical portion. For example, the vertical portion ranging metric may comprise the minimum ranging metrics within the vertical portion. In some embodiments, the vertical portion ranging metric may be determined based on a statistical analysis of the ranging metrics within the vertical portion.

The ranging metric represents a distance to a nearest target object corresponding to a real-world location associated with a pixel location. In some embodiments, the ranging metric of a pixel location may correspond to depth value or intensity value.

Referring now to FIG. 6, the set of all possible binary object detection maps 680 for a detection field-of-view (e.g., detection field-of-view 570) segmented into four vertical portions (e.g., vertical portions 572a – 572d) are depicted. As depicted in FIG. 6, each binary object detection map 680 includes a binary object detection value 682. The binary object detection value 682 indicates if an object was detected within the associated vertical portion of the detection field-of-view. For example, as depicted in FIG. 6, a one may indicate that an object was detected in the corresponding vertical portion, while a zero indicates that an object was not detected in the corresponding vertical portion.

As further depicted in FIG. 6, the plurality of vertical portions comprising each binary object detection map 680 include a set of left vertical portions 686, a set of center vertical portions 684, and a set of right vertical portions 688. In some embodiments, the detection field-of-view 570 may be segmented into more than four vertical portions. In such an embodiment, the plurality of vertical portions may be down-sampled into four vertical portions, for example, by performing a logical OR on one or more binary object detection values 682 of neighboring vertical portions.

As further depicted in FIG. 6, the binary object detection maps 680 are divided into four groups 684a – 684d based on the selected rotation direction of an example process for determining a rotation direction (e.g., process 332).

The binary object detection value 682 for each vertical object of the set of center vertical portions 684 is zero for each binary object detection map 680 in group 684a. Such binary object detection maps 680, indicate no objects are detected in a forward direction from the mobile autonomous electronic system. As described in relation to FIG. 3, in such situations, the mobile autonomous electronic system enters a drive state in which the drive mechanism is activated, and the previous rotation direction is reset.

The binary object detection maps 680 comprising group 684b all indicate a detected object in at least one of the set of center vertical portions 684. However, each of the binary object detection maps 680 indicate a clear path is more likely to the left of the detection field-of-view than to the right. For example, either one of the vertical portions of the set of right vertical portions 688 indicates a detected object and the set of left vertical portions 686 does not, or a right vertical portion of the set of center vertical portions 684 indicates a detected object and a left vertical portion of the set of center vertical portions 684 does not indicate a detected object. As further described in relation to FIG. 3, if the previous rotation direction is not set, in such situations, the selected rotation direction is set to left (counter-clockwise).

The binary object detection maps 680 comprising group 684c all indicate a detected object in at least one of the set of center vertical portions 684. However, each of the binary object detection maps 680 indicate a clear path is more likely to the right of the detection field-of-view than to the left. For example, either one of the vertical portions of the set of left vertical portions 686 indicates a detected object and the set of right vertical portions 688 does not, or a left vertical portion of the set of center vertical portions 684 indicates a detected object and a right vertical portion of the set of center vertical portions 684 does not indicate a detected object. As further described in relation to FIG. 3, if the previous rotation direction is not set, in such situations, the selected rotation direction is set to right (clockwise).

The binary object detection maps 680 comprising group 684d provide an uncertain direction. For example, a detected object is indicated in at least one of the set of center vertical portions 684. Further, there is no indication whether the left of the detection field-of-view or the right of the detection field-of-view is more likely to provide a clear path. As further described in relation to FIG. 3, if the previous rotation direction is not set, in such situations, the rotation direction is determined based on the vertical portion ranging metric for each vertical portion. For example, the direction may be chosen to avoid the closest detected object in the detection field-of-view.

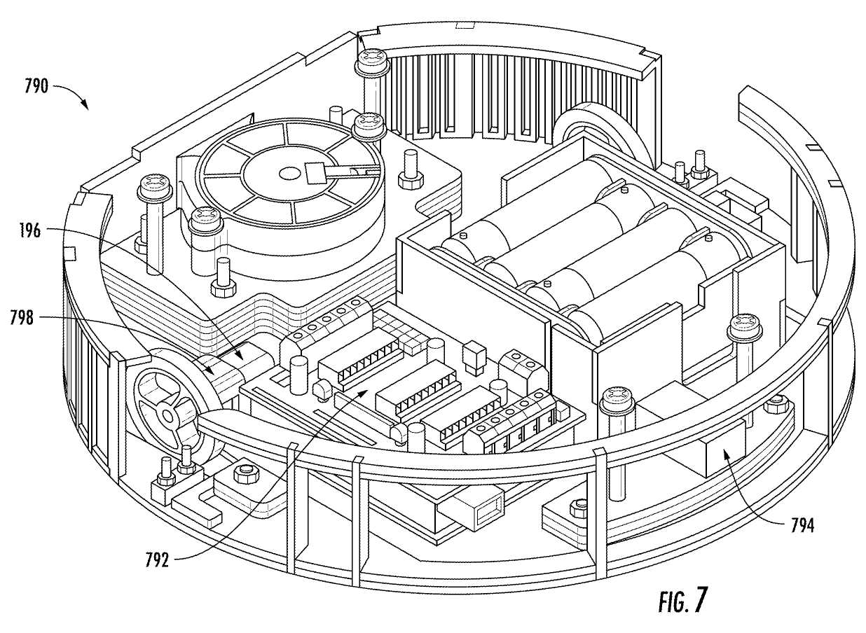

Referring now to FIG. 7, a perspective view of an example mobile autonomous electronic system (e.g., robotic vacuum 790) is provided. As depicted in FIG. 7, the example robotic vacuum 790 includes a controller 792 electrically connected to a drive mechanism 798 and a rotation mechanism 796. The controller 792 is further electrically connected to a ranging sensor 794 directed out the front of the robotic vacuum 790. As depicted in FIG. 7, in some embodiments, the drive mechanism 798 and the rotation mechanism 796 may comprise the same components, wherein driving and rotating are based on the coordination of the rotation speeds of the wheels of the robotic vacuum 790.

Referring now to FIG. 8, FIG. 8 illustrates an example controller 102 in accordance with at least some example embodiments of the present disclosure. The controller 102 includes processor 802, input/output circuitry 804, data storage media 806, and communications circuitry 808. In some embodiments, the controller 102 is configured, using one or more of the sets of circuitry 802, 804, 806, and/or 808, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the controller 102 provide or supplement the functionality of other particular sets of circuitry. For example, the processor 802 in some embodiments provides processing functionality to any of the sets of circuitry, the data storage media 806 provides storage functionality to any of the sets of circuitry, the communications circuitry 808 provides network interface functionality to any of the sets of circuitry, and/or the like.

In some embodiments, the processor 802 (and/or co-processor or any other processing circuitry assisting or otherwise associated with the processor) is/are in communication with the data storage media 806 via a bus for passing information among components of the controller 102. In some embodiments, for example, the data storage media 806 is non-transitory and may include, for example, one or more volatile and/or non-volatile memories. In other words, for example, the data storage media 806 in some embodiments includes or embodies an electronic storage device (e.g., a computer readable storage medium). In some embodiments, the data storage media 806 is configured to store information, data, content, applications, instructions, or the like, for enabling the controller 102 to carry out various functions in accordance with example embodiments of the present disclosure.

The processor 802 may be embodied in a number of different ways. For example, in some example embodiments, the processor 802 includes one or more processing devices configured to perform independently. Additionally, or alternatively, in some embodiments, the processor 802 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the controller 102, and/or one or more remote or “cloud” processor(s) external to the controller 102.

In an example embodiment, the processor 802 is configured to execute instructions stored in the data storage media 806 or otherwise accessible to the processor. Alternatively, or additionally, the processor 802 in some embodiments is configured to execute hard-coded functionality. As such, whether configured by hardware or software methods, or by a combination thereof, the processor 802 represents an entity (e.g., physically embodied in circuitry) capable of performing operations according to an embodiment of the present disclosure while configured accordingly. Alternatively, or additionally, as another example in some example embodiments, when the processor 802 is embodied as an executor of software instructions, the instructions specifically configure the processor 802 to perform the algorithms embodied in the specific operations described herein when such instructions are executed.

In some embodiments, the controller 102 includes input/output circuitry 804 that provides output to the user and, in some embodiments, to receive an indication of a user input. In some embodiments, the input/output circuitry 804 is in communication with the processor 802 to provide such functionality. The input/output circuitry 804 may comprise one or more user interface(s) (e.g., user interface) and in some embodiments includes a display that comprises the interface(s) rendered as a web user interface, an application user interface, a user device, a backend system, or the like. The processor 802 and/or input/output circuitry 804 comprising the processor may be configured to control one or more functions of one or more user interface elements through computer program instructions (e.g., software and/or firmware) stored on a memory accessible to the processor (e.g., data storage media 806, and/or the like). In some embodiments, the input/output circuitry 804 includes or utilizes a user-facing application to provide input/output functionality to a client device and/or other display associated with a user.

In some embodiments, the controller 102 includes communications circuitry 808. The communications circuitry 808 includes any means such as a device or circuitry embodied in either hardware or a combination of hardware and software that is configured to receive and/or transmit data from/to a network and/or any other device, circuitry, or module in communication with the controller 102. In this regard, the communications circuitry 808 includes, for example in some embodiments, a network interface for enabling communications with a wired or wireless communications network. Additionally, or alternatively in some embodiments, the communications circuitry 808 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 808 includes circuitry for interacting with the antenna(s) and/or other hardware or software to cause transmission of signals via the antenna(s) or to handle receipt of signals received via the antenna(s). In some embodiments, the communications circuitry 808 enables transmission to and/or receipt of data from a client device in communication with the controller 102.

Additionally, or alternatively, in some embodiments, one or more of the sets of circuitries 802-914 are combinable. Additionally, or alternatively, in some embodiments, one or more of the sets of circuitries perform some or all of the functionality described associated with another component. For example, in some embodiments, one or more sets of circuitries 802-808 are combined into a single module embodied in hardware, software, firmware, and/or a combination thereof. Similarly, in some embodiments, one or more of the sets of circuitr(ies) is/are combined such that the processor 802 performs one or more of the operations described above with respect to each of these circuitries individually.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that may benefit from detecting presence and/or motion of target objects proximate the electronic device. For example, robotic vacuums, robotic mops, robotic lawn mowers, smart speakers, virtual assistants, motion detect lights, motion detect cameras, household appliances, smart thermostats, and so on.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A mobile autonomous electronic system, comprising:
an optical ranging sensor configured to generate a ranging metric for each pixel location in a detection field-of-view;
a rotation mechanism configured to rotate the mobile autonomous electronic system in a rotation direction;
a drive mechanism configured to drive the mobile autonomous electronic system relative to the rotation direction; and
a controller configured to:
segment the detection field-of-view into a plurality of vertical portions;
generate a binary object detection map comprising a binary object detection value associated with each vertical portion based on a plurality of ranging metrics comprising the vertical portion, wherein the binary object detection value indicates a detected object in the associated vertical portion; and
determine the rotation direction of the mobile autonomous electronic system to avoid the detected object based on the binary object detection map.

2. The mobile autonomous electronic system of claim 1 comprising:
a drive state, wherein the drive mechanism is enabled; and
a rotate state, wherein the rotation mechanism rotates the mobile autonomous electronic system in the rotation direction.

3. The mobile autonomous electronic system of claim 2, wherein the controller is further configured to:
store the rotation direction as a previous rotation direction.

4. The mobile autonomous electronic system of claim 3, wherein in an instance in which the rotation direction is uncertain, the controller is further configured to:
determine the rotation direction based on the previous rotation direction.

5. The mobile autonomous electronic system of claim 4, wherein in an instance in which the mobile autonomous electronic system enters the drive state, the controller is further configured to:
reset the previous rotation direction.

6. The mobile autonomous electronic system of claim 2, wherein the controller is further configured to:
determine a vertical portion ranging metric for each vertical portion based on the plurality of ranging metrics comprising the vertical portion.

7. The mobile autonomous electronic system of claim 6, the plurality of vertical portions comprising:
a set of left vertical portions associated with a left side of the detection field-of-view;
a set of right vertical portions associated with a right side of the detection field-of-view; and
a set of center vertical portions associated with a center portion of the detection field-of-view.

8. The mobile autonomous electronic system of claim 7, wherein in an instance in which the binary object detection value associated with each vertical portion comprising the set of center vertical portions indicates no detected object, the controller enters the drive state of the mobile autonomous electronic system and activates the drive mechanism.

9. The mobile autonomous electronic system of claim 7, wherein in an instance in which at least one of the binary object detection values of the set of center vertical portions indicates the detected object, the rotation direction is selected based on the binary object detection map and the vertical portion ranging metric associated with the set of left vertical portions and right vertical portions.

10. The mobile autonomous electronic system of claim 9, wherein in an instance in which the rotation direction is uncertain, the rotation direction is determined based on the vertical portion ranging metrics associated with each vertical portion.

11. The mobile autonomous electronic system of claim 6, wherein the binary object detection value is determined by comparing the vertical portion ranging metric of a vertical portion with a detected object threshold.

12. The mobile autonomous electronic system of claim 1, wherein the plurality of vertical portions includes four vertical portions.

13. A computer-implemented method for avoiding detected objects on a mobile autonomous electronic system, the computer-implemented method comprising:
determining a ranging metric for each pixel location in a detection field-of-view of an optical ranging sensor;
segmenting the detection field-of-view into a plurality of vertical portions;
generating a binary object detection map comprising a binary object detection value associated with each vertical portion based on a plurality of ranging metrics comprising the vertical portion, wherein the binary object detection value indicates a detected object in the associated vertical portion; and
determining a rotation direction of the mobile autonomous electronic system to avoid the detected object based on the binary object detection map.

14. The computer-implement method of claim 13, further comprising:
storing the rotation direction as a previous rotation direction.

15. The computer-implemented method of claim 14, wherein in an instance in which the rotation direction is uncertain, the computer-implemented method further comprises:
determine the rotation direction based on the previous rotation direction.

16. The computer-implemented method of claim 15, further comprising:
determining a vertical portion ranging metric for each vertical portion based on the plurality of ranging metrics comprising the vertical portion.

17. The computer-implemented method of claim 16, wherein in an instance in which the binary object detection value associated with each vertical portion comprising a set of center vertical portions associated with a center portion of the detection field-of-view indicates no detected object, the computer-implemented method further comprises:
entering a drive state of the mobile autonomous electronic system; and
activating a drive mechanism on the mobile autonomous electronic system.

18. The computer-implemented method of claim 17, wherein in an instance in which the mobile autonomous electronic system enters the drive state, the computer-implemented method further comprises:
resetting the previous rotation direction.

19. The computer-implemented method of claim 16, wherein the binary object detection value is determined by comparing the vertical portion ranging metric of a vertical portion with a detected object threshold.

20. A computer program product for avoiding detected objects on a mobile autonomous electronic system, the computer program product comprising at least one non-transitory computer-readable storage medium having computer-readable program code portions stored therein, the computer-readable program code portions comprising an executable portion configured to:
determine a ranging metric for each pixel location in a detection field-of-view of an optical ranging sensor;
segment the detection field-of-view into a plurality of vertical portions;
generate a binary object detection map comprising a binary object detection value associated with each vertical portion based on a plurality of ranging metrics comprising the vertical portion, wherein the binary object detection value indicates a detected object in the associated vertical portion; and
determine a rotation direction of the mobile autonomous electronic system to avoid the detected object based on the binary object detection map.
